(19) United States
(12) Patent Application Publication
(10) Pub. No.: US 2024/0017615 A1
(43) Pub. Date: Jan. 18, 2024

(54) COMMUNITY AND SOCIAL MEDIA SYSTEM FOR A VEHICLE

(71) Applicant: Harman International Industries, Incorporated, Stamford, CT (US)

(72) Inventors: Camellia Nakhjiri, Los Gatos, CA (US); Glenn Grant-Richards, Los Gatos Mountains, CA (US); Maria Praveen Kumar Yatagiri, Bengaluru (IN); Mahsa Nakhjiri, Los Gatos, CA (US)

(21) Appl. No.: 18/349,839

(22) Filed: Jul. 10, 2023

(30) Foreign Application Priority Data
Jul. 18, 2022 (IN) 202241040990

(51) Int. Cl. B60K 35/00; G06Q 50/00

(52) U.S. Cl. CPC B60K 35/00; G06Q 50/01; B60K 2370/164; B60K 2370/56; B60K 2370/152

(57) ABSTRACT

Systems and methods are provided herein for a social network providing real-time and/or interactive entertainment experiences in an automotive environment. In one example, a method comprises detecting, by a social networking system, a first user of the social networking system; determining a social graph of the first user, wherein the social graph comprises a plurality of nodes and edges; determining a location of the first user; determining recommendations for activities for the first user based on the social graph and the location of the first user; and displaying, via a display screen of a user device of the first user, an application of the social networking system based on the social graph and location of the first user, wherein the first user is one of a vehicle user and a person user.

### CROSS REFERENCE TO RELATED APPLICATIONS

The present application claims priority to Indian Provisional Application No. 202241040990, entitled “COMMUNITY AND SOCIAL MEDIA SYSTEM FOR A VEHICLE”, and filed on Jul. 18, 2022. The entire contents of the above-listed application are hereby incorporated by reference for all purposes.

### FIELD

The disclosure relates generally to social networking systems and more particularly to a community and social media system for a vehicle.

### BACKGROUND

Internet-based social networking has become a ubiquitous part of day-to-day life for people around the world. Websites like Facebook™, Twitter™, and the like are regularly used by hundreds of millions of people. Each of these sites, and others, allows people to connect to each other within the site, typically based on some common or shared bond, such as being friends, coworkers, classmates, relatives, or through sharing some common interest, like music, sports, religion, hobbies, etc., or simple curiosity. For the purposes of this application, the generic term “friend” or “friends” will be used to indicate one or more interconnected users within a particular Internet-based social networking system, and the generic terms “social network” or “social networks” will be used as a placeholder for such systems.

The majority of the current social media applications and/or networks rely on building a network of friends based on previous interactions and friends of friends, etc., as described above. However, when on the move in a vehicle, challenges arise in connecting with acquaintances who are far away from the vehicle's current location. The inventors herein have recognized the issues described above. As such, the inventors have recognized that a dynamic social network of like-minded fellow travelers on the road may allow connection between people, wherein the social network, via an application, allows participants to share localized information and engage in interactive activities.

### SUMMARY

Systems and methods are described for providing real-time and/or interactive entertainment experiences in an automotive environment. The approaches may use various network and/or cloud platforms, including ultra-low latency, high computational, and/or localized, edge computing.

The present application presents, in an example, an ad-hoc social network in an area (such as a geographic area or network coverage area, or another physical area) for connecting and engaging real-time and/or interactive activities like gaming, live video sharing, pictures, emojis etc. The network is based on the vehicles themselves, and also optionally based on the users in addition to the vehicles themselves, wherein users, or participants, may be vehicle users or person users. The application may be displayed on a user device, such as an infotainment system screen for vehicle users and a mobile device screen for person users. The application may detect, via a social networking system, a first user, determine a social graph of the first user, determine a location of the first user, and based on the determined social graph and location of the first user, determine recommendations for activities, such as friend recommendations, place of interest (POI) recommendations, and game recommendations, and display, via the user device, the application, including one or more sub-applications such as a local feed, a gaming tab, and an interactive map.

The social network application can provide various features, including: 1) avatars and/or profiles for vehicles; 2) avatars and/or profiles for participants; 3) the ability to collaboratively play games; 4) the ability to share localized information on routes, points of interests, etc.; 5) the ability to share content (photos, videos, stories, etc.); and 6) and sharing of live videos (localized only). In this way, the social network application herein disclosed may provide an area for vehicles and participants in vehicles to interact with each other through a social network to provide increased connection between people on the road, especially when vehicles are within the same region as each other.

### BRIEF DESCRIPTION OF THE DRAWINGS

The disclosure may be better understood from reading the following description of non-limiting embodiments, with reference to the attached drawings, wherein below:

FIG. 1 is a high-level block diagram of a system for a social networking system;

FIG. 2 illustrates an example of a social graph of the social networking system;

FIG. 3 shows a user or person-centric based social network;

FIG. 4 shows a localized social network;

FIG. 5 shows an illustration of a social networking application;

FIG. 6 shows an example of an automatic matchmaking functionality of the social networking system; and

FIG. 7 shows a diagram of an example in-vehicle computing system and infotainment center of a vehicle.

FIG. 8 shows an example profile of a user.

FIG. 9 shows a flowchart illustrating a method for coordinated usage of the social networking system.

FIG. 10 shows a flowchart illustrating a method for determining content to display to a user of the social networking system.

### DETAILED DESCRIPTION

The following description relates to systems and methods for a vehicle social networking application implemented via a social networking system. The social networking system disclosed herein can enable vehicles as participants optionally independent from and separate from other person-based users in a dynamic and continuous manner as well as participant vehicles linked to person-based users. The social networking system can also monitor the participants' activities to identify content objects subject to the participant's privacy settings. The social networking system includes applications that allow users to collaboratively play games, share localized information on routes and points of interest, share photos and videos as stories, share live videos with identified local participants, and more.

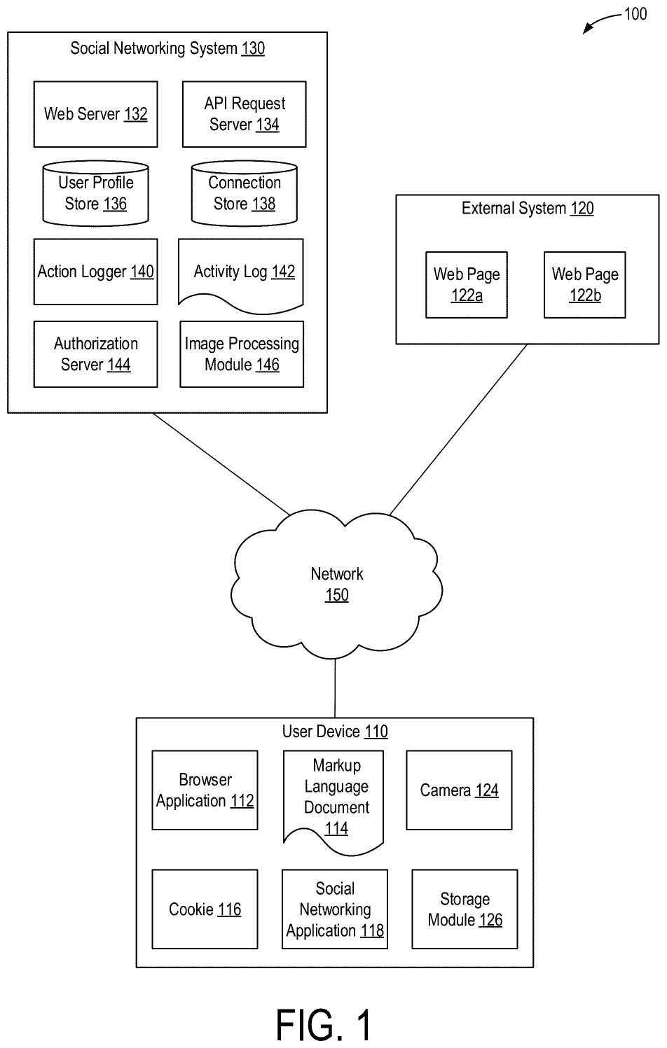

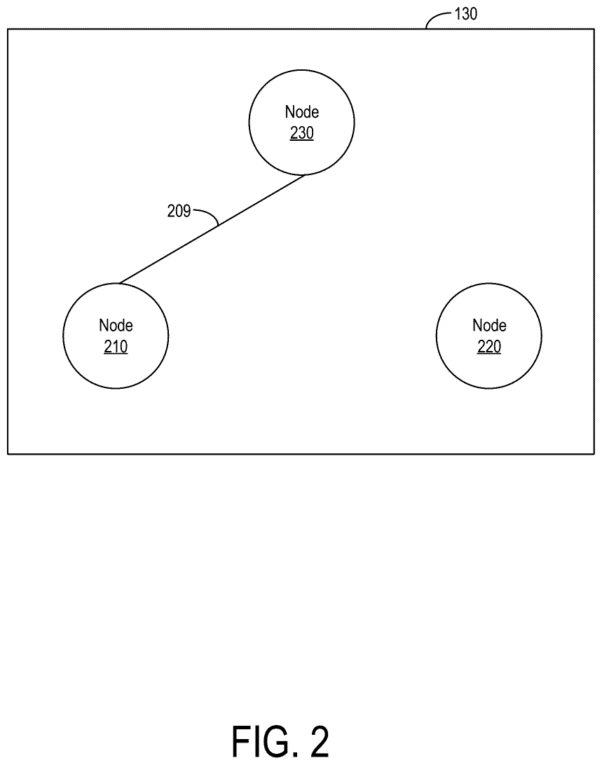

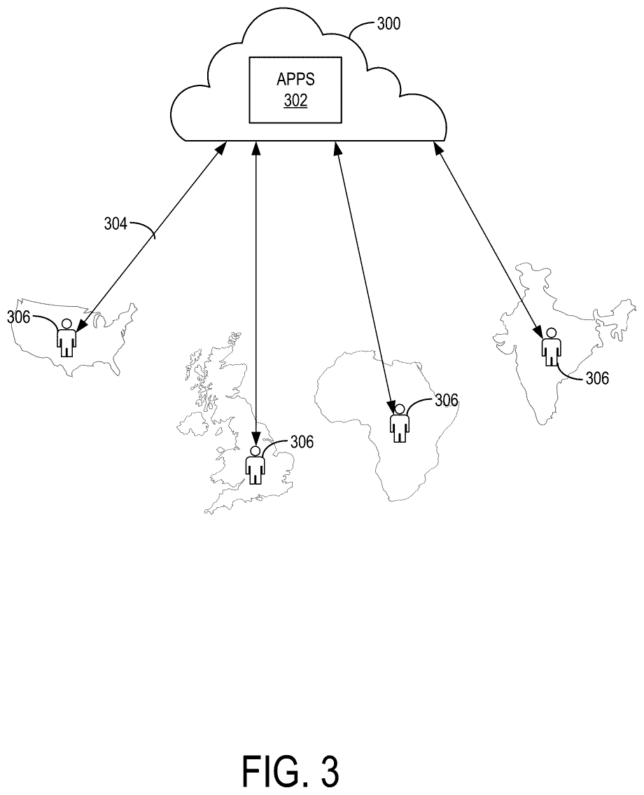

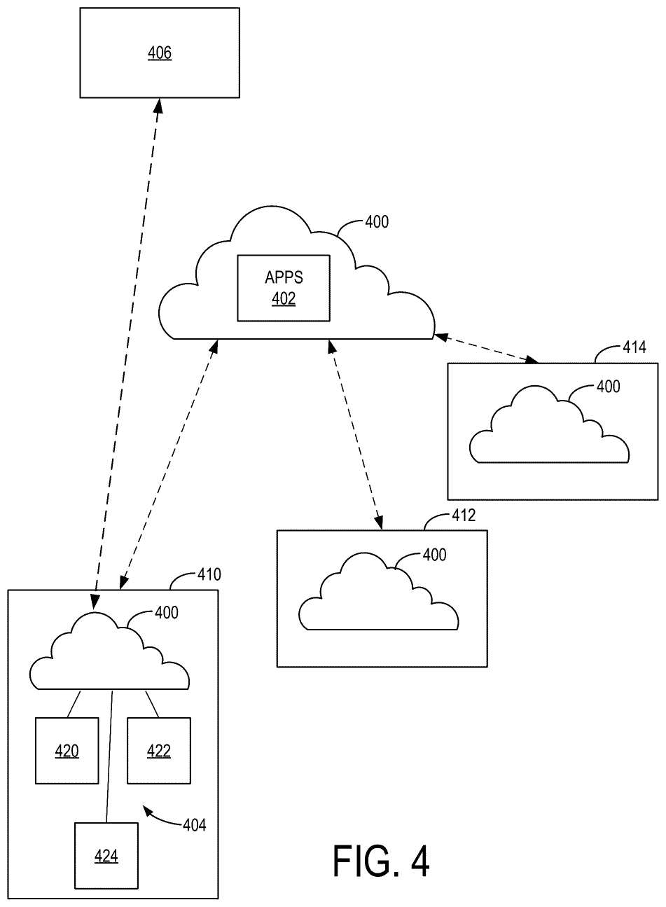

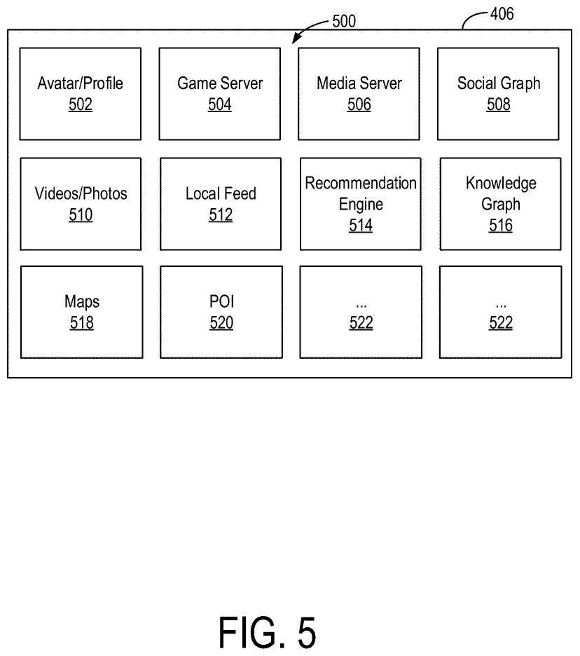

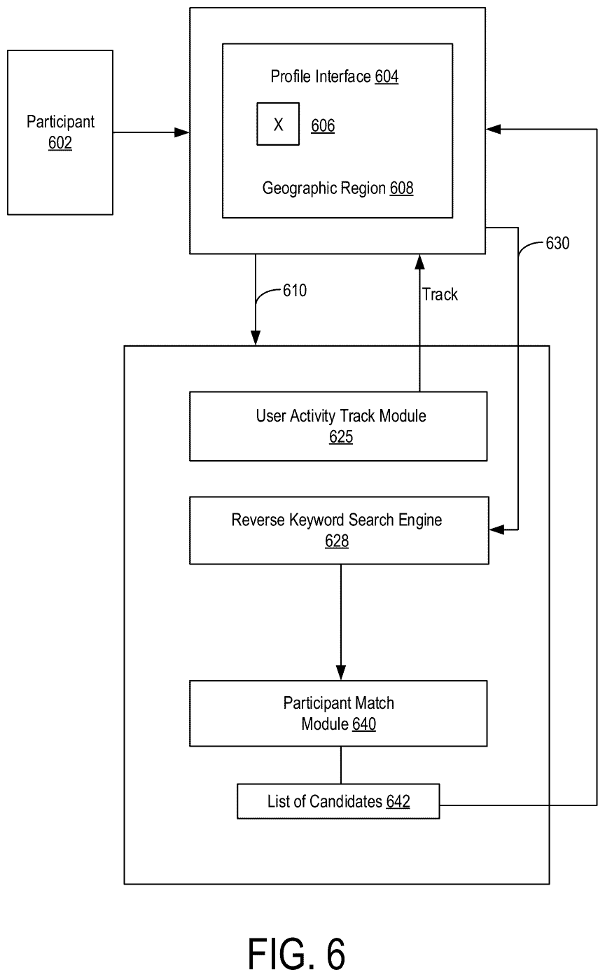

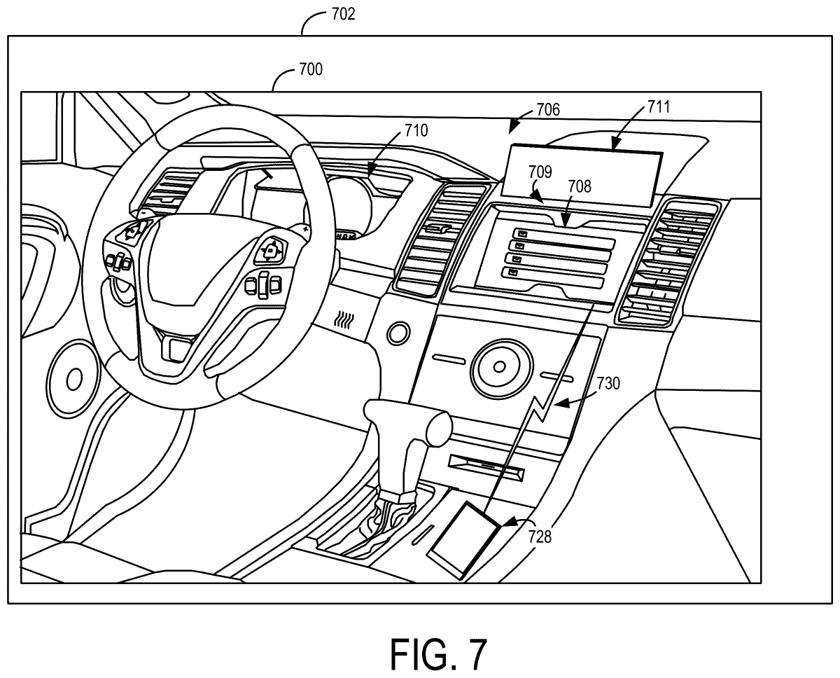

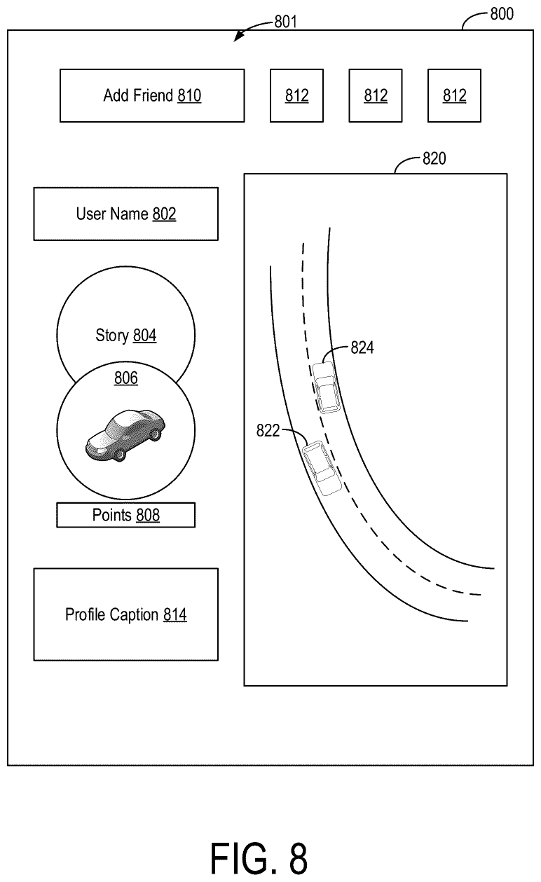

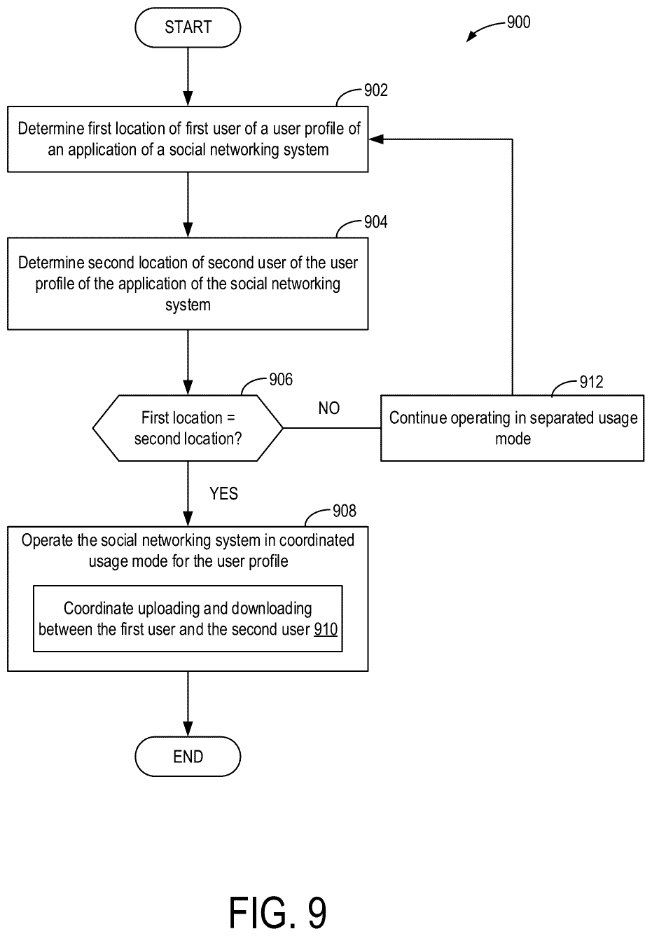

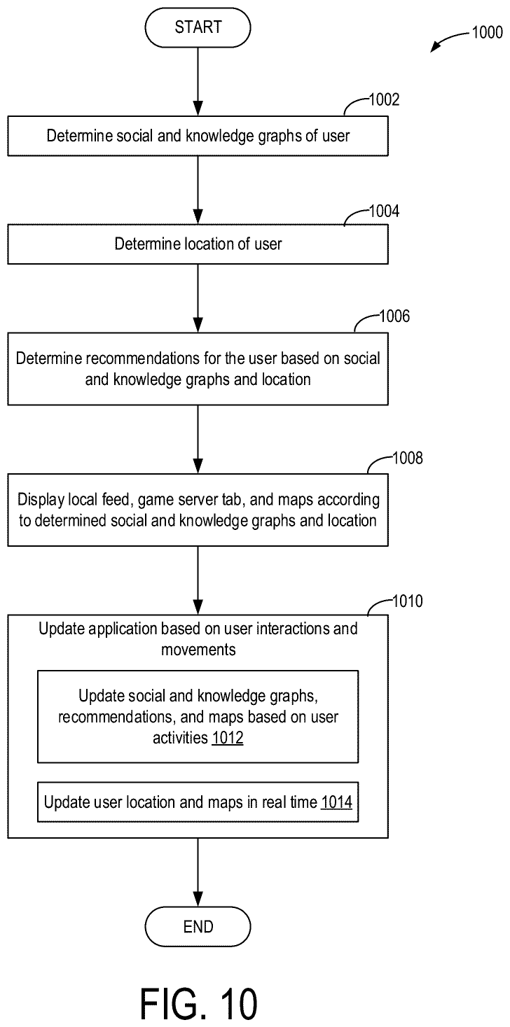

The systems will now be described, by way of example, with reference to the figures. FIG. 1 is a high-level block diagram illustrating a computing environment for a social networking system. FIG. 2 shows an example of a social graph stored in a graph information store as may be included in the social networking system. FIG. 3 illustrates an example of a person-centric social networking system as may be implemented at least in part by the social networking system disclosed herein. FIG. 4 illustrates an example of a localized, ephemeral social networking system as may be implemented at least in part by the social networking system disclosed herein. FIG. 5 shows an illustration of a social networking application and sub-applications thereof. FIG. 6 shows an automatic matchmaking functionality of the social networking system. FIG. 7 shows an example of an in-vehicle computing system and infotainment system through which the social networking system and social network application may be executed and/or displayed. FIG. 8 shows an example of a user profile. FIG. 9 illustrates a method for coordinated usage mode when users of the same user profile are detected in the same location. FIG. 10 illustrates a method for determining content to display to a user.

FIG. 1 is a network diagram of a system 100 for providing and sharing images within a social network in accordance with an embodiment of the invention. The system 100 includes one or more user devices 110, one or more external systems 120, the social networking system 130, and a network 150. For purposes of illustration, the embodiment of the system 100, shown by FIG. 1, includes a single external system 120 and a single user device 110. However, in other embodiments, the system 100 may include more user devices 110 and/or more external systems 120. In certain embodiments, the social networking system 130 is operated by a social network provider, whereas the external systems 120 are separate from the social networking system 130 in that they may be operated by different entities. In various embodiments, however, the social networking system 130 and the external systems 120 operate in conjunction to provide social networking services to users (or members) of the social networking system 130. In this sense, the social networking system 130 provides a platform or backbone, which other systems, such as external systems 120, may use to provide social networking services and functionalities to users across the Internet.

The user device 110 comprises one or more computing devices that can receive input from a user and transmit and receive data via the network 150. In one embodiment, the user device 110 is a conventional computer system executing, for example, a Microsoft Windows compatible operating system (OS), Apple OS X, and/or a Linux distribution. In another embodiment, the user device 110 can be a device having computer functionality, such as a smartphone, a tablet, a personal digital assistant (PDA), a mobile telephone, etc. In yet another embodiment, the user device 110 may be a vehicle itself operating a computing system. The user device 110 is configured to communicate via the network 150. The user device 110 can execute an application, for example, a browser application that allows a user of the user device 110 to interact with the social networking system 130. In another embodiment, the user device 110 interacts with the social networking system 130 through an application programming interface (API) provided by the native operating system of the user device 110, such as iOS and ANDROID. The user device 110 is configured to communicate with the external system 120 and the social networking system 130 via the network 150, which may comprise any combination of local area and/or wide area networks, using wired and/or wireless communication systems.

In one embodiment, the network 150 uses standard communications technologies and protocols. Thus, the network 150 can include links using technologies such as Ethernet, 802.11, worldwide interoperability for microwave access (WiMAX), 3G, 4G, 5G, COMA, GSM, LTE, digital subscriber line (DSL), Edge Computing, etc. Similarly, the networking protocols used on the network 150 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 150 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 110 may display content from the external system 120 and/or from the social networking system 130 by processing a markup language document 114 received from the external system 120 and from the social networking system 130 using a browser application 112. The markup language document 114 identifies content and one or more instructions describing formatting or presentation of the content. By executing the instructions included in the markup language document 114, the browser application 112 displays the identified content using the format or presentation described by the markup language document 114. For example, the markup language document 114 includes instructions for generating and displaying a web page having multiple frames that include text and/or image data retrieved from the external system 120 and the social networking system 130. In various embodiments, the markup language document 114 comprises a data file including extensible markup language (XML) data, extensible hypertext markup language (XHTML) data, or other markup language data. Additionally, the markup language document 114 may include JavaScript Object Notation (JSON) data, JSON with padding (JSONP), and JavaScript data to facilitate data-interchange between the external system 120 and the user device 110. The browser application 112 on the user device 110 may use a JavaScript compiler to decode the markup language document 114.

The markup language document 114 may also include, or link to, applications or application frameworks such as FLASH™ or Unity™ applications, the Silverlight™ application framework, etc.

In one embodiment, the user device 110 also includes one or more cookies 116 including data indicating whether a user of the user device 110 is logged into the social networking system 130, which may enable modification of the data communicated from the social networking system 130 to the user device 110. In one embodiment, the user device 110 also includes one or more social networking applications 118, a camera 124, and a storage module 126.

The external system 120 includes one or more web servers that include one or more web pages 122a, 122b, which are communicated to the user device 110 using the network 150. The external system 120 is separate from the social networking system 130. For example, the external system 120 is associated with a first domain, while the social networking system 130 is associated with a separate social networking domain. Web pages 122a, 122b, included in the external system 120, comprise markup language documents 114 identifying content and including instructions specifying formatting or presentation of the identified content.

The social networking system 130 includes one or more computing devices for a social network, including a plurality of users, and providing users of the social network with the ability to communicate and interact with other users of the social network. In some instances, the social network can be represented by a graph, e.g., a data structure including edges and nodes. Other data structures can also be used to represent the social network, including but not limited to databases, objects, classes, meta elements, files, or any other data structure.

Users may join the social networking system 130 and then add connections to any number of other users of the social networking system 130 to whom they desire to be connected. As used herein, the term “friend” refers to any other user of the social networking system 130 to whom a user has formed a connection, association, or relationship via the social networking system 130. For example, in an embodiment, if users in the social networking system 130 are represented as nodes in the social graph, the term “friend” can refer to an edge formed between and directly connecting two user nodes.

Connections may be added explicitly by a user or may be automatically created by the social networking system 130 based on common characteristics of the users (e.g., users who are alumni of the same educational institution). For example, a first user specifically selects a particular other user to be a friend. Connections in the social networking system 130 are usually in both directions, but need not be, so the terms “user” and “friend” depend on the frame of reference. Connections between users of the social networking system 130 are usually bilateral (“two-way”), or “mutual,” but connections may also be unilateral, or “one-way.” For example, if Bob and Joe are both users of the social networking system 130 and connected to each other, Bob and Joe are each other's connections. If, on the other hand, Bob wishes to connect to Joe to view data communicated to the social networking system 130 by Joe, but Joe does not wish to form a mutual connection, a unilateral connection may be established. The connection between users may be a direct connection; however, some embodiments of the social networking system 130 allow the connection to be indirect via one or more levels of connections or degrees of separation.

In addition to establishing and maintaining connections between users and allowing interactions between users, the social networking system 130 provides users with the ability to take actions on various types of items supported by the social networking system 130. These items may include groups or networks (e.g., social networks of people, entities, and concepts) to which users of the social networking system 130 may belong, games in which a user might be interested, computer-based applications that a user may use via the social networking system 130, transactions that allow users to buy or sell items via services provided by or through the social networking system 130, and interactions with advertisements that a user may perform on or off the social networking system 130. These are just a few examples of the items upon which a user may act on the social networking system 130, and many others are possible. A user may interact with anything that is capable of being represented in the social networking system 130 or in the external system 120, separate from the social networking system 130, or coupled to the social networking system 130 via the network 150.

The social networking system 130 is also capable of linking a variety of entities. For example, the social networking system 130 enables users to interact with each other as well as external systems 120 or other entities through an API, a web service, or other communication channels. The social networking system 130 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 130. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight. An example of a social graph is shown in FIG. 2.

The social networking system 130 also includes user-generated content, which enhances a user's interactions with the social networking system 130. User-generated content may include anything a user can add, upload, send, or “post” to the social networking system 130. For example, a user communicates posts to the social networking system 130 from a user device 110. Posts may include data such as status updates or other textual data, location information, images such as photos, videos, links, music or other similar data and/or media. Content may also be added to the social networking system 130 by a third-party. Content “items” are represented as objects in the social networking system 130. In this way, users of the social networking system 130 are encouraged to communicate with each other by posting text and content items of various types of media through various communication channels. Such communication increases the interaction of users with each other and increases the frequency with which users interact with the social networking system 130.

The social networking system 130 includes a web server 132, an API request server 134, a user profile store 136, a connection store 138, an action logger 140, an activity log 142, an authorization server 144, and an image processing module 146. In an embodiment of the invention, the social networking system 130 may include additional, fewer, or different components for various applications. Other components, such as network interfaces, security mechanisms, load balancers, failover servers, management and network operations consoles, and the like are not shown so as to not obscure the details of the system.

The user profile store 136 maintains information about user accounts, including biographic, demographic, and other types of descriptive information, such as vehicle type (in the case of a vehicle user and a vehicle belonging to a person user), travel destination, hobbies or preferences, location, and the like that has been declared by users or inferred by the social networking system 130. This information is stored in the user profile store 136 such that each user is independently identified. The social networking system 130 also stores data describing one or more connections between different users in the connection store 138. The connection information may indicate users who have similar or common work experience, group memberships, hobbies, or educational history. Additionally, the social networking system 130 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 130, such as non-person entities, buckets, cluster centers, images, interests, pages, external systems, concepts, and the like are also stored in the connection store 138.

The social networking system 130 maintains data about objects with which a user may interact. To maintain this data, the user profile store 136 and the connection store 138 store instances of the corresponding type of objects maintained by the social networking system 130. Each object type has information fields that are suitable for storing information appropriate to the type of object. For example, the user profile store 136 contains data structures with fields suitable for describing a user's account and information related to a user's account. When a new object of a particular type is created, the social networking system 130 initializes a new data structure of the corresponding type, assigns an object identifier to it, and begins to add data to the object as needed. This might occur, for example, when a user becomes a user of the social networking system 130, the social networking system 130 generates a new instance of a user profile in the user profile store 136, assigns an identifier to the user account, and begins to populate the fields of the user account with information provided by the user.

The connection store 138 includes data structures suitable for describing a user's connections to other users, connections to external systems 120 or connections to other entities. The connection store 138 may also associate a connection type with a user's connections, which may be used in conjunction with the user's privacy setting to regulate access to information about the user. In an embodiment of the invention, the user profile store 136 and the connection store 138 may be implemented as a federated database.

Data stored in the connection store 138, the user profile store 136, and the activity log 142 enables the social networking system 130 to generate the social graph that uses nodes to identify various objects and edges connecting nodes to identify relationships between different objects. For example, if a first user establishes a connection with a second user in the social networking system 130, user accounts of the first user and the second user from the user profile store 136 may act as nodes in the social graph. The connection between the first user and the second user stored by the connection store 138 is an edge between the nodes associated with the first user and the second user. Continuing this example, the second user may then send the first user a message within the social networking system 130. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 130 (or, alternatively, in an image maintained by another system outside of the social networking system 130). The image may itself be represented as a node in the social networking system 130. This tagging action may create edges between the first user and the second user as well as create an edge between each of the users and the image, which is also a node in the social graph. In yet another example, if a user confirms attending an event, the user and the event are nodes obtained from the user profile store 136, where the attendance of the event is an edge between the nodes that may be retrieved from the activity log 142. By generating and maintaining the social graph, the social networking system 130 includes data describing many different types of objects and the interactions and connections among those objects, providing a rich source of socially relevant information.

In some examples, one or more users may be linked to a single account and thereby share data in the activity log 142. For example, a first user that is a vehicle may be linked to a first user account and a second user that is a person may also be linked to the first user account. The first and second users may be separate entities and therefore be independently identified even though they share the first user account. In some instances, displayed content within the one or more social networking applications 118 for the first and second users that are both linked to the first user account may depend upon determined geographic location, whether each user is currently active on the one or more social networking applications 118, and so forth, as will be further described.

The web server 132 links the social networking system 130 to one or more user devices 110 and/or one or more external systems 120 via the network 150. The web server 132 serves web pages, as well as other web-related content, such as Java, JavaScript, Flash, XML, and so forth. The web server 132 may include a mail server or other messaging functionality for receiving and routing messages between the social networking system 130 and one or more user devices 110. The messages can be instant messages, queued messages (e.g., email), text and SMS messages, or any other suitable messaging format.

The API request server 134 allows one or more external systems 120 and user devices 110 to call access information from the social networking system 130 by calling one or more API functions. The API request server 134 may also allow external systems 120 to send information to the social networking system 130 by calling APIs. The external system 120, in one embodiment, sends an API request to the social networking system 130 via the network 150, and the API request server 134 receives the API request. The API request server 134 processes the request by calling an API associated with the API request to generate an appropriate response, which the API request server 134 communicates to the external system 120 via the network 150. For example, responsive to an API request, the API request server 134 collects data associated with a user, such as the user's connections that have logged into the external system 120, and communicates the collected data to the external system 120. In another embodiment, the user device 110 communicates with the social networking system 130 via APIs in the same manner as external systems 120.

The action logger 140 is capable of receiving communications from the web server 132 about user actions on and/or off the social networking system 130. The action logger 140 populates the activity log 142 with information about user actions, enabling the social networking system 130 to discover various actions taken by its users within the social networking system 130 and outside of the social networking system 130. Any action that a particular user takes with respect to another node on the social networking system 130 may be associated with each user's account, through information maintained in the activity log 142 or in a similar database or other data repository. Examples of actions taken by a user within the social networking system 130 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 130, the action is recorded in the activity log 142. In one embodiment, the social networking system 130 maintains the activity log 142 as a database of entries. When an action is taken within the social networking system 130, an entry for the action is added to the activity log 142. The activity log 142 may be referred to as an action log.

In some examples, the action logger 140 may be further configured for determining a location of the user device 110. In other examples, a separate location logger module may be included in the social networking system 130. Determining a location of the user device 110, either via the action logger 140 or via a separate location logger module, may include utilization of a global positioning system (GPS) or other positioning system that is configured to determine a geographic location of the user device 110. In some examples, more than one user device may be located to the same location, such as in the instance of a first user being a vehicle and a second user being a person within the vehicle. A location may be an exact coordinate or a larger geographic area, such as a region of a defined area (e.g., 400 square yards), a city, a particular highway within a region, and the like. A location may be iteratively updated, such as a vehicle travels.

In some examples, the action logger 140 or other location logger may only determine a location of the user device 110 if the user device 110 is actively using the social networking system 130. In other examples, the action logger 140 may determine a location of the user device 110 anytime, even if the user device 110 is not actively using the social networking system 130. Location determination may be subject to a user's privacy settings. In some examples, if more than one user device is located to the same location (e.g., the same coordinates) and the more than one user device are identified as linked to each other (e.g., linked to the same user account) coordinated usage of content may be used. For example, activity or actions from the more than one user device may be considered the same activity and may be stored only once. In this way, the system 100 provided herein may reduce bandwidth and processing as overlapping activities may be accounted for and only logged (e.g., downloaded and/or uploaded) and stored one time.

Further, when user devices linked to the same user account, such as a vehicle user and a person user, are located at separate locations, the user devices may be treated as separate and coordinated usage of content may not be used. As such, feeds and/or other components of an application accessible through the social networking system 130 may include posts and/or other activities from all users. For example, a first user that is a vehicle may upload a photo of traffic to the feed and a second user that is a person may post a comment to the feed. The first user may view the second user's post in the feed and the second user may view the first user's photo in the feed. Alternatively, if the first and second users belong to the same profile and are located in the same location, one of the first or second users posting a photo, comment, etc. to a feed may result in both users being shown as having posted.

Additionally, user actions may be associated with concepts and actions that occur within an entity outside of the social networking system 130, such as an external system 120 that is separate from the social networking system 130. For example, the action logger 140 may receive data describing a user's interaction with an external system 120 from the web server 132. In this example, the external system 120 reports a user's interaction according to structured actions and objects in the social graph.

Other examples of actions where a user interacts with an external system 120 include a user expressing an interest in an external system 120 or another entity, a user posting a comment to the social networking system 130 that discusses an external system 120 or a web page 122 a within the external system 120, a user posting to the social networking system 130 a Uniform Resource Locator (URL) or other identifier associated with an external system 120, a user attending an event associated with an external system 120, or any other action by a user that is related to an external system 120. Thus, the activity log 142 may include actions describing interactions between a user of the social networking system 130 and an external system 120 that is separate from the social networking system 130.

In some examples, the activity log 142 may be specific to a user account. In other examples, the activity log 142 may be specific to a particular user of the user account. As explained above, one or more users may be linked to the same user account, e.g., a vehicle as well as a person may both be linked to a user account. The activity log 142 may receive communications and store data particular to one of the users of an account or all users of an account. For example, data may be stored to all users of an account when all users are located in the same location. Data may be stored to a particular one of the users of an account when the particular one user is located separate from other users of the account. Each user of the user account may have individual profiles under the same umbrella user profile for the account. Each user's profile may be interacted with individually or the umbrella user profile may be interacted with as a whole. As is described above, when all users of an account are located in the same location, activities done by one user may be logged to each user. Further, content may be uploaded/downloaded only once when all users are located in the same location. In this way, the system may reduce processing demands and bandwidth used when operating in coordinated usage mode when users of the same account are located in the same location.

The authorization server 144 enforces one or more privacy settings of the users of the social networking system 130. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 120, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 120. One embodiment allows the specification of the set of entities to comprise an enumeration of entities. For example, the user may provide a list of external systems 120 that are allowed to access certain information. Another embodiment allows the specification to comprise a set of entities along with exceptions that are not allowed to access the information. For example, a user may allow all external systems 120 to access the user's work information, but specify a list of external systems 120 that are not allowed to access the work information. Certain embodiments call the list of exceptions that are not allowed to access certain information a “block list”. External systems 120 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 144 contains logic to determine if certain information associated with a user can be accessed by a user's friends, external systems 120, and/or other applications and entities. The external system 120 may need authorization from the authorization server 144 to access the user's more private and sensitive information, such as the user's work phone number. Based on the user's privacy settings, the authorization server 144 determines if another user, the external system 120, an application, or another entity is allowed to access information associated with the user, including information about actions taken by the user.

The image processing module 146 of the social networking system 130 and the social networking application 118 of the user device 110 may provide image management capabilities. In an embodiment, the image processing module 146 receives images captured by the camera 124 within the user device 110 or provided to the user device 110 from another source. In some examples, the camera 124 may be incorporated into the user device 110. For example, the camera 124 may be incorporated or otherwise built into a smart phone for user by a person user. In another example, the camera 124 may be incorporated into the vehicle, for example as a sensor, and may be configured to capture images upon request or automatically. The images may be saved to a storage module 126 within the user device 110. The social networking application 118 or the operating system of the user device 110 may upload images to the social networking system 130, where they may be saved to an archive of a user by the image processing module 146. The image processing module 146 may also include images in archives of multiple users in response to requests to share images received from users of the social networking system 130.

Users may take advantage of the collaborative features and functionality of the social networking system 130 to upload and share digital images. Users of the social networking system 130 may upload images for display on their user profiles. For example, a user of the social networking system 130 may upload a profile picture that features prominently on her profile and identifies her to friends and other users. As another example, a user of the social networking system 130 may upload or otherwise select a digital representation of itself (e.g., an avatar, animated avatar, etc), for example for vehicle users, an illustration of a vehicle may be uploaded or chosen to represent the vehicle user. The avatars, illustrations, and other depictions may represent a personality of the user and may be viewed by other users of the social network, including friends and/or users determined to be within the same geographic location as the user. In this context, within the same geographic location as the user may mean that a geographic distance between the location of the user and the location of the other user is within a threshold distance.

A user may also upload a cover image that may be displayed as a banner across the top of the user's profile. In addition to images for display on user profiles, users may also upload images for sharing with other users, such as photographs of an event or place of interest, photographs of traffic, photographs from nature, or any other type of digital images. Images uploaded by users may be published on their profile pages as posts or as temporary “stories” or in their news feeds which may be viewed by other users according to the user's privacy settings, or on the profile pages or in the news feeds of other users. Users may also tag other users in uploaded images. A tag is an association of an image with a user that, for example, indicates that the user appears in the image. When a user is tagged in an image, the image is associated with the user and may be included in an album or other user-specified grouping of images of the user, a profile page of the user, a news feed of the user, etc.

Participants, e.g., users, may be looking for a way to connect and share information in a meaningful way on social networking system 130. While one approach to generate edges between nodes is to build the network of friends based on previous interactions and friends of friends etc. as described above, social networking system 130 enables building of the network based on mobility. For example, for a vehicle participant, when on the move with a user in the vehicle, it is not be as easy to be connected to friends who are physically far away from the user. Thus, social networking system 130 can, in one embodiment, provide a dynamic social network of like-minded fellow travelers on the road for connection and building of the network. Allowing such participants to share geographically localized information relative to a physical position and/or other traveling information of the participants, and engaging in interactive activities like games etc., can make the traveling journey more memorable. Also giving a profile and a personality for the vehicle itself as a participant and allowing the vehicle participant to be part of the social network along with human-based users provides an interesting and more effective way of enjoying the rides (while maintaining privacy protections, etc.).

Such interactions on social networking system 130 thus can feel more real as interactions with the entities close to the participant are prioritized. Further, the interactions can be provided in real time. Further, the interaction is focused on what is happening locally to the participant. As such, the social networking system 100 may employ both a person-centric network as well as a local network.

FIG. 2 shows an example of a social graph stored by the social networking system 130 of FIG. 1. Node 210 is a node in the social graph that represents a first participant object (e.g., a first user). Node 220 is a node in the social graph that represents a second participant object (e.g., a second object). Node 230 is a node in the social graph that represents a content object. In some embodiments, the node 230 can represent a content object such as an image, a video, an audio, a text, a post, a webpage, or a URL.

The participant represented by the node 210 (also referred to as “participant 210”) may interact with the content object represented by the node 230 (also referred to as “content object 230”). For example, the participant 210 may click to view a webpage 230. Or, the participant 210 may comment on an image 230. Or, the participant 210 may click a Like button of a video 230 to indicate that the participant 210 likes the video 230. The social networking system 130 may detect the interaction between the participant 210 and the content object 230. Accordingly, the social networking system 130 may add an edge 209 between the nodes 210 and 230 to represent the interaction relationship between the nodes.

As is described with respect to FIG. 1, users may indicate content objects and other users (e.g., nodes) with which their profile may be shared, viewed, or accessed. For example, an edge indicating a friend relationship between two users may indicate that photos, posts, etc. shared by the each of the two users may be included in a feed shown to the other of the two users, the users may appear, when active, as potential collaborators for cooperative games, and the like.

In other examples, if a user's privacy settings are set to public, their profile, as well as posts or other activities, may be presented to the feed or other application components to other users within the same geographic region. For example, if a first user is located within a first geographic region and the first user's privacy settings are set to public, a second user within the first geographic region may see, for example, the first user's posted photo of a place of interest or may see the first user as an available opponent for an interactive game. In this way, user's feeds may be tailored to their geographic location, thereby reducing the amount of irrelevant posts shown to the user.

Further, as will be further described, when an edge between to users indicates that the users are friends, the user's posts, activities, and online status may be shown to each other both when they are in the same geographic location and when in different locations. For example, a post of a first user may be shown to a second user when the first and second users are friends when the first user is in a first geographic location and the second user is in a second geographic location. In this way, the feed shown to a user may include both data of friends as well as data of nearby users whose privacy settings allow public sharing.

Turning now to FIG. 3, an example of a person-centric network 300 is shown. The person-centric network 300 may allow individual participants 306 to connect to the network 300 and to each other regardless of location. The network 300 may be at least part of the network 150 of FIG. 1. For example, as is depicted in FIG. 3, the individual participants 306 may be located in different continents, countries, and other types of geographic regions. Each connection 304 between a user 306 and the network 300 may be individual and the users may connect to each other via the network 300. Users 306 located in any location may have edges therebetween, such as friend relationships, that indicates that posts, statuses, and the like of one user may be shown in to the other user.

The network 300 may run a plurality of applications 302, which may be the one or more applications 118 of FIG. 1. In some examples, the applications 302 may all be connected to each other or, in other examples, may be independent from one another. The applications 302 may be accessible via a user device (e.g., a client device such as a smart phone or an infotainment center of a vehicle).

Turning now to FIG. 4, an example of local networks 400 is shown. The local networks 400 may be based on participants, which includes both vehicles themselves as well as users of the vehicles. The local networks 400 may be at least part of the network 150 of FIG. 1. The local networks 400 may be accessible in and/or accessible from a plurality of geographic locations, wherein the local network for a particular geographic location is distinct from another local network for a different geographic location. For example, the local networks 400 may be independently accessible from a first location 410, a second location 412, and/or a third location 414 such that the local networks 400 are distinct from one another. The local networks 400 may detect or otherwise connect with one or more participants within each of the plurality of geographic locations. For example, the local networks 400 may connect with one or more participants 404. The one or more participants 404 may be located within the first location 410. When each within one of the plurality of geographic locations, the local networks 400 may allow the one or more participants 404 to connect with each other through the local networks 400.

For example, the one or more participants 404 may access applications 402 via the local network of the first location 410. The applications 402 may include one or more applications that are run on the social networking system 130. One or more of the applications 402 may comprise sub-applications thereof. In some examples, an application of the applications 402 may be accessible via the local network of the first location 410, wherein the application, such as application 406, is location based and therefore specific to the first location 410 in which itis accessed. The application 406 may also be accessed by users within other locations, such as the second location 412, although the application 406 may include different content therein when accessed from the second location 412 than when accessed from the first location 410. In this way, the application 406 may provide tailored content to the user based on geographic location determination. In some examples, this may reduce bandwidth used as the user may be shown relevant data in a more efficient manner, reducing demand for searching and/or scrolling to find relevant data or posts.

The application 406 may be a vehicle and user based social media application and may include sub-applications such as a local feed, points of interest, game server, and more. The one or more participants 404 may connect with each other via the applications 402, including the application 406. As an example, two of the one or more participants 404 may connect to the game server and play a game against and/or with each other. As another example, a first participant may upload a post to the local feed and a second participant may view and interact with the past, such as liking the post or commenting on the post.

In some examples, the social networking system 130 as herein described may employ both a local network and a person-centric network, whereby participants may access the local network and connect with other participants in the same geographic location as well as see, interact with, or otherwise connect with participants, for example their friends, outside their geographic location. Additionally, data of the social networking system 100 may be locally processed and stored, whereby activities, postings, and the like may initially be stored locally and then depending on the type of activity, may be stored long term within the person-centric network.

As described with respect to FIG. 1, a location of a user may be updated iteratively in real-time (e.g., without intentional delay) as the user moves. For example, a vehicle user's location may be updated as the vehicle travels down a road. The content of the network, including the content of applications, for example an interactive map application that displays locations of users via positioning of corresponding avatars within a map, may be updated in real time based on the iteratively updated location of the vehicle user.

In some examples, certain types of content may only be shared by a user with other users within the same geographic region. For example, a first user 420 of the one or more participants 404 may share information of a local place of interest and/or a route to a destination, as a couple examples, with a second user 422 and a third user 424 when each of the first user 420, the second user 422, and the third user 424 are located within the first location 410. The information of the local place of interest and/or the route from the first user 420 may not be shared with users located within the second or third locations 412, 414. In other examples, information of the local place of interest and/or the route may be shared with users in the same location and/or users in different locations.

In an example, the methods and system may utilize edge computing. Edge Computing includes a paradigm in which the processing of the data takes place physically closer to where the data is being produced or consumed. Applying this in the vehicle context may provide advantages such as lower access latency, localization, and faster/efficient access to cached information. Cellular (4G/5G) networks may offer options for edge computing. For example, rather than hauling and processing the data in the far-cloud in the datacenter across the internet, the computational/storage resources can be located on edge nodes closer to the vehicles on the edge of a radio network, or in the operator's core network. The data coming from/going to the vehicle can be inspected/processed on the edge nodes with near real-time latencies.

In an example, some or all of the relevant data is locally processed and stored locally. The networks are also ephemeral which are mostly short term while some could be promoted to long term (via traditional social media networks) The content and the interactions are very relevant to the location and moves as the vehicle moves.

In one embodiment, the social networking system can have a feature to introduce or recommend participants who share one or more interests and/or who share mobility content (e.g. a “Participants You Should Meet” feature). For example, the social networking system can send a private system message to a participant indicating that another participant shares a common feature. Or, the social networking system identifies that participants A and B share a common physical location or other mobility feature and sends a notice to participant A suggesting that participant A attend an event because participant B also plans to attend the event.

The social networking system can conduct the matchmaking functionality without participants' intervention. Turning briefly to FIG. 6, an example of the automatic matchmaking functionality of the social networking system 130 is shown. A participant 602 of the social networking system 130 can set up the profile of the participant 602 to instruct the social networking system 130 that the participant 602 wants to opt-in to the automatic matchmaking functionality. For example, the participant 602 can click an opt-in checkbox 606 in a participant profile interface page 604 for the automatic matchmaking functionality. The participant 602 can further identify the geographic region 608 in the participant profile on which the matchmaking functionality should focus, which may be a present location or a destination if en route, or a geographic region in which the participant is traveling. In another embodiment, the social networking system 130 can automatically identify the geographic region based on the participant profile or participant activity history without intervention from the participant 602. The choice that the participant 602 made is sent to the social networking system 130 as an instruction 610.

Upon receiving the instruction 610, the social networking system 130 continues to track the participant activities of the participant 602 including the participant's interactions with content objects such as pictures, videos, audios, texts or any other type of media content. There may be various user interactions being tracked by the social networking system. For example, the participant may click an application, post a comment to a posted message, or click a Like button to express the appreciation of an online article. In some examples, the social networking system 130 includes a participant activity track module 625 dedicated to monitoring and detecting the participants' interaction with content objects. The monitoring and tracking are subject to the participant's privacy settings.

Each time the social networking system 130 detects a content object with which the participant has interactions, the social networking system conducts a search in its search engine 628 based on the interacted content object 630 mobility data such as relative geographic locations thereof.

Periodically, the social networking system 130 may use a participant match module 640 to search candidates who have mobility data matched with the participant 602, among participants located in the target geographic region. In some examples, the social networking system 130 provides the participant 602 with a list of candidates 642. The list of candidates 642 is accompanied by the matched mobility data objects. The social networking system 130 may further provide links to communicate with the candidates. For example, the participant 602 may click one entry of the list of candidates to access a participant interface to provide and send a system message to a candidate. In some examples, the system initially conceals the identities of the candidates from the participant 602 to protect participant privacy. In some examples, the system may show a candidates profile avatar only. The system may later reveal the identity of a candidate once the candidate confirms the reveal request or the candidate starts to interact with the participant 602. During the automatic matching process, the participant 602 does not need to specify any characteristics of potential matching candidates. As noted, the candidates included in the list of candidates 642 may be based on the geographic location of the participant 602. In other examples, one or more of the candidates in the list of candidates 642 may be based on the participant's activities or existing friends.

The social networking system 130 may automatically track and analyze the participant 602's activities to assess the interests of the participant 602. The tracking is subject to the participant's privacy settings. Based on the information from the automatic tracking, the social networking system is able to present matching candidates to the participant 602 periodically. In one embodiment, the participant 602 can choose the frequency for receiving matching candidate suggestions. In another embodiment, the social networking system automatically determines the frequency based on the participant activities of the participant 602.

Returning to FIG. 4, as described, the matchmaking functionality as described with respect to FIG. 6 may be based on the local network 400, wherein potential matches are based at least in part on geographic location of the user. In this way, the local network 400 may allow for increased connections (e.g., via increased edges between nodes) while increasing processing speed as the data thereof is stored locally. In other examples, the matchmaking functionality may also employ a person-centric network, such as the network 300, which uses stored data, like friendships, to suggest potential candidates.

Turning now to FIG. 5, the application 406 is shown. As described, the application 406 may be accessed by a user via a user device through the local network 400 and the social networking system 130. The application 406 may contain content specific to the user and to the geographic location of the user. The application 406 may comprise a plurality of sub-applications 500 (e.g., tabs). The plurality of sub-applications 500 may share data with each other via the network such that content objects, nodes, edges, and activities of the user within one of the plurality of sub-applications 500 is known to the other sub-applications and may affect the displayed content (e.g., list of candidates from the matchmaking functionality, avatars displayed on the maps, etc.) for the other sub-applications.

The application 406 may be displayed as a selectable element on the user device. For example, the application 406 may be displayed via an infotainment center of a car, as a widget on a smart phone display screen, and the like. Further, the application 406, in some examples, may be running, including posting photos, sharing comments, and the like, with and/or without user input. For example, a user input such as a touch to a touch screen, a voice command, and the like, may indicate that an action is to be taken. In other examples, based on preprogrammed settings, an action may be taken without user input.

One or more of the plurality of sub-applications 500 may also be displayed as selectable elements following opening of the application 406. The plurality of sub-applications 500 may include an avatar/profile application 502, a game server 504, a media server 506, a social graph 508, a videos/photos application 510, a local feed 512, a recommendation engine 514, a knowledge graph 516, a maps application 518, a place of interest (POI) application 520, and one or more other applications 522. While the plurality of sub-applications 500 are depicted in the figure as a grid of selectable elements, other configurations are possible. As an example, upon launching of the application 406, the local feed 512 may be displayed initially, with the other sub-applications accessible via a side panel and/or selectable elements displayed along with or as part of the local feed 512. For example, a user avatar element may be displayed as part of the local feed 512, the user avatar element being selectable to launch the avatar/profile application 502.

Further, not all of the plurality of sub-applications 500 may be selectable by the user. For example, in some examples, the media server 506, the social graph 508, the recommendation engine 514, and/or the knowledge graph 516 may be applications that operate in the background for the application 406 and may not be selectable elements displayed by the user device.

The avatar/profile application 502 may allow the user to create, select, or otherwise distinguish an avatar (or other type of illustration) for the user. As previously described, the user may be a vehicle or a person. The avatar/profile application 502 may further allow the user to choose privacy settings including whether their profile and/or avatar are visible to the public, friends, friends and friends of friends, or other group of users. Further, the avatar/profile application 502 may allow users to designate multiple users to one profile. For example, a profile may include a vehicle user, a first person user, and a second person user. In some examples, chosen avatars may be interactive such that when the vehicle user is detected in the same location and the first person user and/or the second person user, the avatars thereof are displayed together. In this way, other users viewing the profile may be able to easily determine whether the first and/or second person users are in the vehicle. Available avatars for a vehicle user may be illustrations of the vehicle, in some examples, and available avatars for a person user may be illustrations of the person user. Available avatars may be customizable to demonstrate personality traits, likes/dislikes, appearance, and more. In some examples, third party applications may be launched from the avatar/profile application 502, wherein an avatar is created within the third party application and then stored and used by the application 406.

The game server 504 may store one or more interactive games accessible to the user. The game server 504 may use the determined geographic location of the user to find other users within the same geographic location which may be displayed as available users to play a game with, cooperatively and/or competitively. Further, in some examples, the game server 504 may use existing edge relationships (e.g., friendships) to determine users outside the user's geographic location that the user may play a game with. The game server 504 may store data of accumulated points from each of the one or more interactive games in order for the user to keep track of progress and skill level. In some examples, the game server 504 may include a feature for one or more of the games that allows the user to play the game either solo or with other people not connected to the application 406. For example, a vehicle user may launch a game, such as twenty questions, for which one or more passengers in the vehicle may play.

The game server 504 may be accessible via a gaming tab of the application. The gaming tab may include a list of a plurality of games available to the user as well as a list of available users with whom the user may play one or more of the plurality of games. The available users may be users within the geographic region of the user and users with whom the user is friends with.

In some examples, a game may be interactive and the game server 504 may restrict access to the game to particular vehicle statuses when the user is a vehicle. For example, for a driving/racing game, the game server 504 may not allow the driving/racing game to be launched when the vehicle is moving and may allow the driving/racing game to be launched when the vehicle is parked. In this way, the social networking system 130 may use vehicle operations to modify what is accessible therein.

In some examples, one or more of the games of the game server 504 may make use of other features of the application 406, such as activity with certain content objects, and the user device, such as the camera, a speaker, and the like. As an example, an interactive singing game may comprise the game server 504 determining a song based on the user's activity (e.g., liking a content object associated with a bad, an artist, or a song), playing one or more snippets of the song for the user to sing along with, sharing audio of the user singing with friends and nearby vehicles/person users, and virtually interacting with the nearby vehicles/person users when the nearby vehicles/person users share some connection with the user, such as being friends, having activity with the same band, artist, or song, and the like.

The media server 506 may store digital media, such as photos, videos, and the like, that are uploaded and/or downloaded via the social networking system 130. The media server 506, in some examples, may be uploading and/or downloading content when a user is active on the network. In such examples, content may not be uploaded and/or downloaded when the user is not active, therefore reducing used bandwidth and decreasing processing power.

The social graph 508 may store data of relationships between nodes, e.g., edges. As is described with respect to FIGS. 1 and 2, each content object (e.g., node) may be known and relationships therebetween (e.g., edges) may be tracked so as to affect content shown to the user.

The videos/photos application 510 may store media content from the media server 506 for display. The videos/photos application 510 may display photos and/or videos shared by users. For example, photos posted as a story, a video posted directly to the feed, and the like may be shown within the videos/photos application 510. The videos/photos application 510 may not show text-only based content. In this way, the user may choose to view only video/photo content, filtering out other types of content. The videos and photos shown may be from users within the same geographic location (subject to privacy settings of each user) as well as from users of known relationships (e.g., friends). In this way, the user may see both content from people they have a relationship with and from people in their vicinity to enhance their experience while traveling.

The videos/photos application 510 may further allow users to upload photos and/or videos of POI, traffic, and/or road incidents. In some examples, shared photos and/or videos of this type may be geo-tagged and may be displayed and accessible from the maps application 518. In some examples, a user may send requests to nearby users (e.g., vehicles in front of them in traffic) to share a photo, either locally with just the user or publically, of the road or a POI in order to make determinations about their own travel. For example, if a view of the road is obstructed in some way for the user, a nearby user may share a photo of the traffic with the user in order to allow the user to make an informed decision about their travel route.

The local feed 512 may display posts, including story posts, video posts, photos, text-only posts (e.g., comments), and the like with respect to the geographic location of the user. For example, the user may launch the local feed 512 to see postings from people in the same geographic region (e.g., within a threshold geographic distance from the user), including posts of POI, local traffic pictures/videos, and more. In this way, the user may view content relevant to their geographic location, which may, in some instances, affect their travel plans, destinations, and the like.

The recommendation engine 514 may include the matchmaking functionality described with respect to FIG. 6 as well as recommendations for game opponents, POI, travel routes (e.g., based on posted traffic data), and the like. The recommendation engine 514 may use data from the social graph 508 and other sub-applications to determine what recommendations to display to the user. Recommendations may include friend recommendations (e.g., a list of candidate participants as is described above), a POI recommendation, and a game recommendation based at least in part on the social graph of the user and the location of the user. Further, one or more of the sub-applications may include a top ranked or top voted list of posts, wherein, for example, a POI that is highly voted on (e.g., by number of likes) may be recommended to the user when they are in the same geographic location (e.g., within a specified radius) as the POI.

The knowledge graph 516, similar to the social graph 508, may store data of nodes and edges. The knowledge graph 516 may store data of known entities (e.g., content objects). While the social graph 508 stores data of relationships between users and content objects within the network, the knowledge graph 516 may store data of the users and the content objects separately [INVENTORS PLEASE CONFIRM/CORRECT].

The maps application 518, as previously discussed with respect to FIG. 1, may display an interactive map. The interactive map may comprise a representation of a geographic region and initially be displayed of the geographic region in which the user is located. User inputs may be received to alter the window to expand or reduce the geographic region displayed. One or more selectable elements may be displayed within the interactive map, including avatars of nearby users, previews of photos and/or videos of traffic and/or POI geotagged to the displayed geographic region, and the like. Each of the one or more selectable elements, when selected, may launch further information regarding the selected element. For example, a user profile, such as is depicted in FIG. 8 may be launched upon user selection of an avatar within the map.

In some examples, avatars of friends may also be shown within the interactive map if the friends are online (e.g., actively accessing the social networking system 130). The avatars shown within the map may be selectable by a user to allow the user to request to initiate a message, a phone call, or to play a game with the user associated with the selected avatar. For example, the user profile that is launched upon user selection may include selectable elements (e.g., widgets) that allow the user to initiate an activity with the user of the user profile.

Additionally, the maps application 518 may include a plurality of maps therein. For example, a first map may include only avatars of users in the same geographic area as the user. A second map may include avatars of users in the same geographic area as well as avatars of existing friends outside the geographic area. A third map may include previews of photos and/or videos of traffic and/or POI. Additional maps may be combinations thereof, showing subsets or all elements herein described. In some examples, the user may select what types of content they desire to be shown within the map, for example via a drop down menu.

The POI application 520 may include uploaded photos, videos, text-only posts, and the like for POI of the geographic region in which the user is located. The POI application 520, in some examples, may provide additional information regarding POIs in posts. The additional information may be provided by users, either those who posted the posts or other users, or may be obtained from a third party source. The POI application 520 may be specific to the geographic region of the user, as noted, and may also be linked to the maps application 518. For example, a selectable element of a preview of a photo of a POI within one of the interactive maps may launch the POI application 520 for the particular photo or a set of photos of the POI in response to user selection of the selectable element.

The application 406 may include other applications 522, such as a music application, a travel route application, among others not specified herein. Each of the other applications may also obtain data from and be configured based on the social graph, knowledge graph, and locations of the user similar to the other sub-applications.

Turning now to FIG. 7, an example partial view of a vehicle including an infotainment system (e.g., a head unit) that may run a social network application and thus be a participant in the social networking system described above is shown. Passengers in the cabin, including the driver, may be additional, separate, participants in the social network described herein, and thus may each be a user in the social network. An interior of a cabin 700 of a vehicle 702, in which a driver and/or one or more passengers may be seated.

As shown, an instrument panel 706 may include various displays and controls accessible to a human driver (which may be a user in the social network as noted above) of vehicle 702. For example, instrument panel 706 may include a touch screen 708 of an in-vehicle computing system or infotainment system 709, an audio system control panel, and an instrument cluster 710. Touch screen 708 may receive user input to in-vehicle computing system or infotainment system 709 for controlling audio output, visual display output, participant preferences, control parameter selection, and so on, as well as for selecting and interacting with applications running on the head unit, including an application for the social network described herein. In further examples, in-vehicle computing system or infotainment system 709 may operate various application, including the social media application described herein.

The infotainment system 709 may be connected to mobile device 728 as described herein. For example, cabin 700 may also include one or more participant objects, such as mobile device 728, that are stored in the vehicle before, during, and/or after travelling. Mobile device 728 may include a smart phone, a tablet, a laptop computer, a portable media player, and/or any suitable mobile computing device. Mobile device 728 may be connected to in-vehicle computing system via a communication link 730. Communication link 730 may be wired (e.g., via Universal Serial Bus (USB), Mobile High-Definition Link (MHL), High-Definition Multimedia Interface (HDMI), Ethernet, and so on) or wireless (e.g., via Bluetooth®, Wi-Fi®, Wi-Fi Direct®, Near-Field Communication (NFC), cellular connectivity, and so on) and configured to provide two-way communication between the mobile device and the in-vehicle computing system. (Bluetooth® is a registered trademark of Bluetooth SIG, Inc., Kirkland, WA. Wi-Fi® and Wi-Fi Direct® are registered trademarks of Wi-Fi Alliance, Austin, Texas.) Mobile device 728 may also operate an application for a user participant of the social network described herein. The user participant may represent the user of the smartphone separate and distinct from the vehicle participant of vehicle 702. In some examples, user inputs to the infotainment system 709, for example via the touch screen 708, when the social media application as herein disclosed is open may indicate activities of the vehicle participant. Conversely, user inputs to the mobile device 728 when the social media application is open may indicate activities of the person participant.

Referring now to FIG. 8, an example user profile 801 of a first user is shown. The user profile 801 may be displayed on a display screen 800 of a user device (e.g., the first user's device and/or a second user's device), such as a screen of an infotainment system of a vehicle in the case of a vehicle participant or a display screen of a mobile computing device in the case of a person participant. The user profile 801 may be displayed, in some examples, in response to user input selecting the first user's avatar within a map, the first user's avatar within a feed, the first user's name as displayed within any of a number of tabs of the social media application herein disclosed, etc. As an example, the user profile 801 may be displayed in response to user selection of the corresponding avatar within an interactive map of the second user's application.

The user profile 801 may comprise a user name 802, which may be a full name, a nickname, or other, a story element 804, an avatar element 806, a profile caption 814, and one or more activity elements. The one or more activity elements may comprise an add friend element 810, which, when selected sends a request to be friends from the selecting user (e.g., the second user) to the first user. Approval of the friend request may create an edge between the first user node and the second user node, establishing a relationship in an associated social graph therebetween. The one or more activity elements may further comprise one or more activity request elements 812. The one or more activity request elements 812 may, as non-limiting examples, comprise a gaming element that when selected sends a request to the first user to play a game with the second user, a music element that when selected sends a snippet of a song, an audio file, or a request to play a singing game, a message element that when selected opens a message thread between the first user and the second user, a traffic element that when selected sends a request to the first user to take a photo or video of the traffic ahead, and the like.

The story element 804, when selected, launches the first user's story, which may include posted videos, photos, avatar animations, and the like. The avatar element 806, when selected may launch a window showing the avatar in greater detail, in some examples the avatar may be animated upon launching. The profile caption 814, which may be customizable by the first user, may be selectable to launch additional information about the first user, including for example a travel destination, place of origin, interests, and more.

The user profile 801 may also optionally comprise a points element 808 that displays an amount of points the first user has accumulated from playing games, interacting with other users, posting to feeds (e.g., local feed and/or POI), and the like. The first user may choose, for example via a settings tab, whether or not to display the points element 808.

The user profile 801 may further comprise an interactive map 820. The interactive map 820 may display relative and/or real positions of the first user and the second user, via a first user vehicle avatar 822 and a second user vehicle avatar 824. In this way, the second user viewing the first user's user profile may be able to determine where in a relative vicinity they are to the first user and therefore make determinations about postings like a POI photo.

FIG. 9 shows a flowchart illustrating a computer-implemented method 900 for operating in coordinated usage based on user location. Method 900 may be performed by any suitable computer-executable code and/or computing system, such as the computing system a user device like a vehicle infotainment system and/or a mobile device. The computing system may store computer-executable instructions instructions in non-transitory memory executable by a processor. The computing system may be connected to the social networking system as herein disclosed, including to both a local network as well as a person-centric network.

At 902, method 900 includes determining a first location of a first user of a user profile (e.g., a user account) of an application of a social networking system. The social networking system may be the social networking system 130 described with respect to FIG. 130. The application may be the application 406 described with respect to FIGS. 4 and 5. The user profile may be stored as part of the application of the social networking system and the user profile may include one or more users connected thereto. While more than one user may be connected to the user profile, each may have a separate profiles within the user profile. The separate profiles may be linked but may have individual social graphs with independent relationships. For example, the first user may be friends with another user but the other users of the user profile may not be friends with the another user. The first location may be determined, in some examples, via GPS or other positioning system included within the computing system of the user device. In some examples, the first user may be a vehicle participant. The determined first location may include a geographic region as well as specific coordinates.

At 904, method 900 includes determining a second location of a second user of the user profile. As noted, the user profile may include one or more users connected thereto such that multiple users of the same user profile are known to be connected to each other. For example, the first user may be the vehicle participant and the second user may be a person participant, in some examples wherein the person participant is a passenger or driver of the vehicle. Similar to the first location, the second location may be determined via GPS or other positioning system and may include a geographic region as well as specific coordinates.

At 906, method 900 includes determining whether the first location and the second location are the same location. The first location and the second location may be the same if the specific coordinates are the same, as such is the case when the person participant is within the vehicle participant. If the first and second locations are the same (YES at 906), method 900 proceeds to 908. If the first and second locations are different (NO at 906), method 900 proceeds to 912.

At 912, method 900 includes continuing to operate in separated usage mode. When the first and second locations are not the same, the first and second users may be treated as separated and uploading and downloading may be performed independently. For example, when a non-user is driving the vehicle and the person participant is located elsewhere, the vehicle participant may be connected to the social networking system independent of the person participant. In this way, the social networking system may determine and display different content for the vehicle participant and the person participant, whereby activities performed by the vehicle participant (e.g., the first user) is not affected by and does not affect activities performed by the person participant (e.g., the second user).

In some examples, one of the first and second users may be offline. For example, the first user may be offline when the infotainment system of the vehicle is not operating the application or when the vehicle is powered off. The second user may be offline when the mobile device is not operating the application or is powered off. In such circumstances, downloading of content may be paused so as to reduce processing power of respective computing systems and to reduce bandwidth used.

At 908, method 900 includes operating the social networking system in coordinate usage mode for the user profile. Coordinated usage mode may comprise coordinating uploading and downloading of content between the first and second users, as noted at 910. Coordinating uploading and downloading may entail uploading content, for example a photo of a POI, to both the first and second user's feeds/stories/etc. when one of the first and second users initiates an upload. In this way, the upload may be viewed by users who have relationships with either of the first and second users. Similarly, content may be downloaded in a coordinated manner to reduce bandwidth used.

In some examples, a prompt may be shown to the first and second users within the application informing the first and second users of detection of same location. The prompt may include a choice to operate in coordinated usage mode or to stay in separated usage mode. If one or more of the users selects to stay in separated usage mode, the users may remain separated and content may be downloaded/uploaded separately. In this way, multiple users within the same vehicle (e.g., a vehicle participant and one or more person participants or two or more person participants) may interact with each other through the application. For example, two person participants using the application on separate user devices may play a game with each other and/or may play a game with a third user not in the vehicle at the same time.

As described previously, determination of locations may be performed in real-time such that a determined location is updated in real time. The method 900 may end following 910, however the method 900 may be continuously performed when determining the location of the first and second user. In this way, real time updates of location may indicate whether or not coordinated usage mode is to be used.

As an example of an implementation of the method 900, a scenario may include a first user A and a second user B. The first user A and the second user B may both be connected to a user account C. Each of the first user A and the second user B may have individual profiles within the user account C. The first user A may be a vehicle A and the second user B may be a person B.

During a first duration, the vehicle A may be operated by a person that is not person B while person B is located elsewhere. During the first duration, the vehicle A may perform activities (e.g., make posts, upload photos, communicate with neighboring vehicles/people, etc.) without input from person B. Also during the first duration, person B may perform activities (e.g., make posts, play interactive games, access maps, etc.) without input from vehicle A. Activities logged by vehicle A and person B during the first duration in which vehicle A is located in a different location than person B may be uploaded and/or downloaded separately. During such time, a feed presented to vehicle A may include posts from person B and a feed presented to person B may include posts from vehicle A, assuming that vehicle A and person B are friends through the social networking system.

In transition between the first duration and a second duration, person B may enter vehicle A such that person B and vehicle A are then in the same location. During the second duration in which vehicle A and person B are in the same location, vehicle A may perform activities and person B may perform activities, though because they are in the same location and coordinated usage mode is enacted, according to method 900 as shown above, activities of vehicle A and person B may be uploaded in a coordinated manner. For example, a video of traffic posted by vehicle A may be posted to a story of both vehicle A and person B. In some examples, coordinated posting may entail grouping user profiles of the account C together and posting under the account C rather than posting under individual profiles. In other examples, posts may be shown as posted by both user profiles. For example, another user may access the posted story from both the profile of vehicle A and the profile of person B, although notation may be made that links the two user profiles (e.g., showing both profile names on the posted story).

In this way, coordinated usage may reduce bandwidth used by uploading and/or downloading posts only once when more than one user of the same account are located together as well as reducing processing demands of the computing system of client devices (e.g., user devices) in the same manner.

Turning now to FIG. 10, a flowchart illustrating a computer-implemented method 1000 for determining content for a user of an application of a social networking system is shown. In some examples, the application may be the application 406 of FIGS. 4 and 5 and the social networking system may be the social networking system 130 of FIG. 1. Method 1000 may be performed by any suitable computer-executable code and/or computing system, such as the computing system a user device like a vehicle infotainment system and/or a mobile device. The computing system may store computer-executable instructions in non-transitory memory executable by a processor. The computing system may be connected to the social networking system as herein disclosed, including to both a local network as well as a person-centric network.

At 1002, method 1000 includes determining social and knowledge graphs of a user. The knowledge graph may include all content objects of the application, including all users, posts, entities, etc. thereof. The social graph may include a graph of relationships between the content objects, whereby a relationship is an edge and a content object is a node, as is described with respect to FIG. 2. The social and knowledge graphs may provide information for which users are connected to the user and therefore whose posts and profiles the user will see in their application regardless of location of the user or the connected users.

At 1004, method 1000 includes determining a location of the user. As described with respect to FIG. 9, the location of the user may include data of both specific coordinates as well as a more generalized geographic region in which the user is located. The determined location may provide data, e.g., to the local network 400, indicating that the user is located within a geographic area. The geographic area may have other users therewithin that may be available for connecting to the user based on being within the same vicinity (e.g., sharing a similar location).

At 1006, method 1000 includes determining recommendations for the user based on social and knowledge graphs and location. Recommendations may include match making, as described with respect to FIG. 6, wherein users are recommended as potential friends to the user, for example within the local feed. Recommendations may also include recommended POI, frequently played games in the geographic area, and more. Recommendations may appear within one or more tabs of the application, for example within the local feed, interactive maps, and the like.

At 1008, method 1000 includes displaying the local feed, a game server tab, and the interactive maps according to the determined social and knowledge graphs and location. For example, the local feed may include content specific to the geographic area in which the user is located. The content may include posts, stories, comments, and the like from users also located within the geographic area. The content may, in some examples, also include posts, stories, comments and the like from existing friends of the user even when located outside the geographic area. The game server tab may display avatars of users located within the geographic area who are available to play a game with and/or against. The game server tab may also display avatars of existing friends located outside the geographic area who are available to play a game with and/or against. The interactive maps, as described previously, may display avatars of users located within the geographic area, elements corresponding to POI within the geographic area, and avatars of existing friends of the user. The interactive maps may be adjustable to show more or less area, demonstrating actual location of the users corresponding to the displayed avatars. In this way, content shown to the user may be tailored based on their social and knowledge graphs and based on their particular location.

At 1010, method 1000 includes updating the application based on user interactions and movements. The social and knowledge graphs, recommendations, and the interactive maps may be updated based on user activities, as noted at 1012. For example, the user creating a new edge (e.g., a new friendship) may add to the social graph and may therefore result in updated recommendations. Further, the new friend may be added to the interactive map.

The user location and the interactive maps may be updated in real time as the user moves, as noted at 1014. For example, for a vehicle user, the location may be updated in real time, showing an actual location of the vehicle user within the interactive map by displaying a corresponding avatar in a correct location. Because the vehicle is moving and the application updates in real time, the avatar may appear to move as well within the interactive maps. The local feed may also be updated as the user moves, wherein posts, stories, and more are added to and/or removed from the feed based on a changing geographic location. For example, when the user is in a first location, the local feed may display a first set of contents. When the user moves to a second, different location, the local feed may display a second set of contents. The first set of contents may be specific to the first location and the user's existing edges and the second set of contents may be specific to the second location and the user's existing edges.

A technical effect of the systems and methods herein disclosed is that processing demands of a computing system of a user device may be reduced based on location determination and coordinated usage. For example, when more than one user associated with a single user profile are determined to be in the same location, uploading/downloading may be reduced as activities may be transmitted only once but associated with each of the users. Further, processing power may be reduced as when a user is inactive (e.g., offline), content and data are not downloaded.

Additionally, the systems and methods provided herein allow users to connect to people and places based on their location as well as existing connections/activities. The application herein disclosed allows for sharing of localized information and engagement in interactive activities between users on the road. Vehicles themselves may be users, therefore increasing connectivity as well.

In another representation, a computer-implemented method comprises detecting, by a social networking system, a first participant of a social networking system interacting with a first mobility content object, the first participant being a vehicle itself; identifying one or more participants of the social networking system that are associated with the first mobility content object as candidate users; and providing a list of one or more of the candidate participants based on the first mobility content object. The method further comprises providing a selectable option to communicate with the one or more of the candidate users. The one or more identified participants is a user of the social networking system and the user is a person. The one or more identified participants is another vehicle separate from every user located within the another vehicle. The method further comprises providing the list of the one or more of the candidate participants within a graphical user interface of a client device associated with the first participant, the user interface being an integral part of the vehicle. The method further comprises providing the list of the one or more of the candidate participants within a graphical user interface of a client device associated with the first participant, the user interface being an integral part of a head unit of the vehicle. The first participant is represented by an emoji. The method further comprises posting images captured by the vehicle to a story of the first participant on the social networking system. Posts from other vehicle participants are posted to a story of the first participant on the social networking system based upon a comparison of mobility content objects of the first vehicle participant and the other vehicle participants, including geographic distance between the vehicles being within a threshold. The providing of the list is in response to the vehicle being a stopped condition. The social networking system detects the first participant interacting with the first content object outside of the social networking system at a previous time period.

In another representation, a non-transitory computer-readable medium stores instructions that, when executed by at least one processor, cause a computer system to: detect, by a social networking system, a first participant of the social networking system having a mobility object in common with another participant; and provide at list of one or more of candidate participants including the another participant, the first participant being a vehicle itself.

In another representation, a non-transitory computer-readable medium stores instructions that, when executed by at least one processor, cause a computer system to: generate, by a social networking system, a story of a first participant of the social networking system based on a mobility object of the first participant, the first participant being a vehicle itself. The instructions further cause the computer system to generate posts to the story based on real-time data captured by sensors of the vehicle. The sensors include a camera of the vehicle, a microphone of the vehicle, and/or combinations thereof. The instructions further cause the computer system to present gaming information to a passenger of the vehicle via a head unit of the vehicle via the social network.

The disclosure also provides support for a computer-implemented method comprising: detecting, by a social networking system, a first user of the social networking system, determining a social graph of the first user, wherein the social graph comprises a plurality of nodes and edges, determining a location of the first user, determining recommendations for activities for the first user based on the social graph and the location of the first user, and displaying, via a display screen of a user device of the first user, an application of the social networking system based on the social graph and location of the first user, wherein the first user is one of a vehicle user and a person user. In a first example of the method, the recommendations for activities comprise at least one of a friend recommendation, a place of interest (POI) recommendation, and a game recommendation. In a second example of the method, optionally including the first example, the application of the social networking system comprises a plurality of sub-applications including a game server, a local feed, a maps application, and a POI application. In a third example of the method, optionally including one or both of the first and second examples, the first user has a user profile comprising an avatar representing the first user, wherein the avatar is displayed within a map in the maps application based on the location of the first user. In a fourth example of the method, optionally including one or more or each of the first through third examples, the method further comprises: detecting a second user of the social networking system and determining a second location of the second user. In a fifth example of the method, optionally including one or more or each of the first through fourth examples, the second user has a second user profile comprising a second avatar representing the second user, wherein the second avatar is displayed within the map in the maps application based on the second location of the second user and wherein the avatar of the first user and the second avatar of the second user are displayed at the same time when the location of the first user and the second location of the second user are in a geographic area. In a sixth example of the method, optionally including one or more or each of the first through fifth examples, the method further comprises: operating the social networking system in coordinated usage mode when the first and second users are in the same location and belong to the same user profile. In a seventh example of the method, optionally including one or more or each of the first through sixth examples, the first and second users are in the same location when a geographic distance between the location of the first user and the second location of the second user is within a threshold distance. In a eighth example of the method, optionally including one or more or each of the first through seventh examples, the plurality of nodes of the social graph are content objects including the first user and the edges of the social graph are connections between content objects indicating relationships therebetween. In a ninth example of the method, optionally including one or more or each of the first through eighth examples, the method further comprises: performing activities according to user inputs from the first user, wherein the activities include at least one of posting a photo, posting a video, posting a comment, interacting with a post, sending a friend request, messaging another user, sending a request to play a game with another user, and playing a game. In a tenth example of the method, optionally including one or more or each of the first through ninth examples, the first user is the vehicle user and the user device is an infotainment system of the vehicle. In a eleventh example of the method, optionally including one or more or each of the first through tenth examples, the first user is the person user and the user device is a mobile device.

The disclosure also provides support for a non-transitory computer storage medium storing computer-executable instructions that, when executed, cause a computer system to: determine a social graph of a first user, wherein the social graph comprises nodes and edges between the nodes, determine a location of the first user, wherein the location includes specific coordinates and a geographic region, configure one or more sub-applications of an application for the first user based on the social graph and the location of the first user, and update the one or more sub-applications in response to activities of the first user, wherein the first user is a vehicle itself. In a first example of the system further storing computer-executable instructions that, when executed, cause the computer system to generate a recommendation of a list of candidate participants for the first user, wherein the list of candidate participants includes users within a threshold of the location of the first user. In a second example of the system, optionally including the first example, the one or more sub-applications include a game server, a local feed, and a maps application. In a third example of the system, optionally including one or both of the first and second examples, the game server comprises one or more games accessible by the first user, the game server further including a list of users with whom the first user may play the one or more games, wherein users of the list of users are within a threshold geographic distance from the first user.

The disclosure also provides support for a non-transitory computer storage medium storing computer-executable instructions that, when executed, cause a computer system to perform a computer-implemented method comprising: determining locations of one or more users of an application of a social networking system, displaying, via respective display screens of user devices, a local feed to the one or more users based on respective determined locations and respective existing friendships, displaying, via the respective display screens of the user devices an interactive map to the one or more users based on the respective determined locations and the respective existing friendships, displaying, via the respective display screens of the user devices, a gaming tab to the one or more users based on the respective determined locations and the respective existing friendships, and performing activities within the application based on user interactions, wherein the one or more users comprise vehicle users and person users. In a first example of the method: the local feed of a user comprises stories, posted images, posted videos, and posted comments from users within a geographic region of the user and from users connected to the user via friendships, the interactive map comprises one or more selectable elements including avatars of users within the geographic region, previews of images of places of interest (POI) within the geographic region, and a representation of the geographic region, wherein interactive map is adjustable to show additional geographic regions, and the gaming tab comprises a list of a plurality of games and a list of available users, wherein the available users are users within the geographic region and users connected to the user via friendships. In a second example of the method, optionally including the first example, the user is a vehicle user and a corresponding user device is an infotainment system of a corresponding vehicle. In a third example of the method, optionally including one or both of the first and second examples, the user is a person user and a corresponding user device is a mobile device.

As used in this application, an element or step recited in the singular and proceeded with the word “a” or “an” should be understood as not excluding plural of said elements or steps, unless such exclusion is stated. Furthermore, references to “one embodiment” or “one example” of the present disclosure are not intended to be interpreted as excluding the existence of additional embodiments that also incorporate the recited features. The terms “first,” “second,” and “third,” etc. are used merely as labels, and are not intended to impose numerical requirements or a particular positional order on their objects. The following claims particularly point out subject matter from the above disclosure that is regarded as novel and non-obvious.

References in this description to “an embodiment”, “one embodiment”, “an example”, “one example”, or the like, mean that the particular feature, structure, function, or characteristic being described is included in at least one embodiment of the present invention. Occurrences of such phrases in this description do not necessarily all refer to the same embodiment, nor are they necessarily mutually exclusive.

The terms “comprises”, “comprising”, “includes”, “including”, “having” and their conjugates mean “including but not limited to”. This term encompasses the terms “consisting of” and “consisting essentially of”.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, an instance or an illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of described herein may include a plurality of “optional” features unless such features conflict.

It is appreciated that certain features of embodiments described herein, which are, for clarity, described in the context of separate embodiments, may also be provided in combination in a single embodiment. Conversely, various features of embodiments described herein, which are, for brevity, described in the context of a single embodiment, may also be provided separately or in any suitable sub-combination or as suitable in any other embodiment described herein. Certain features described in the context of various embodiments are not to be considered essential features of those embodiments, unless the embodiment is inoperative without those elements.

Although the embodiments described herein have been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the embodiments described herein. To the extent that section headings are used, they should not be construed as necessarily limiting. In addition, any priority document(s) of this application is/are hereby incorporated herein by reference in its/their entirety.

1. A computer-implemented method comprising:
detecting, by a social networking system, a first user of the social networking system;
determining a social graph of the first user, wherein the social graph comprises a plurality of nodes and edges;
determining a location of the first user;
determining recommendations for activities for the first user based on the social graph and the location of the first user; and
displaying, via a display screen of a user device of the first user, an application of the social networking system based on the social graph and location of the first user, wherein the first user is one of a vehicle user and a person user.

2. The computer-implemented method of claim 1, wherein the recommendations for activities comprise at least one of a friend recommendation, a place of interest (POI) recommendation, and a game recommendation.

3. The computer-implemented method of claim 1, wherein the application of the social networking system comprises a plurality of sub-applications including a game server, a local feed, a maps application, and a POI application.

4. The computer-implemented method of claim 3, wherein the first user has a user profile comprising an avatar representing the first user, wherein the avatar is displayed within a map in the maps application based on the location of the first user.

5. The computer-implemented method of claim 4, further comprising detecting a second user of the social networking system and determining a second location of the second user.

6. The computer-implemented method of claim 5, wherein the second user has a second user profile comprising a second avatar representing the second user, wherein the second avatar is displayed within the map in the maps application based on the second location of the second user and wherein the avatar of the first user and the second avatar of the second user are displayed at the same time when the location of the first user and the second location of the second user are in a geographic area.

7. The computer-implemented method of claim 5, further comprising operating the social networking system in coordinated usage mode when the first and second users are in the same location and belong to the same user profile.

8. The computer-implemented method of claim 7, wherein the first and second users are in the same location when a geographic distance between the location of the first user and the second location of the second user is within a threshold distance.

9. The computer-implemented method of claim 1, wherein the plurality of nodes of the social graph are content objects including the first user and the edges of the social graph are connections between content objects indicating relationships therebetween.

10. The computer-implemented method of claim 1, further comprising, performing activities according to user inputs from the first user, wherein the activities include at least one of posting a photo, posting a video, posting a comment, interacting with a post, sending a friend request, messaging another user, sending a request to play a game with another user, and playing a game.

11. The computer-implemented method of claim 1, wherein the first user is the vehicle user and the user device is an infotainment system of the vehicle.

12. The computer-implemented method of claim 1, wherein the first user is the person user and the user device is a mobile device.

13. A non-transitory computer storage medium storing computer-executable instructions that, when executed, cause a computer system to:
determine a social graph of a first user, wherein the social graph comprises nodes and edges between the nodes;
determine a location of the first user, wherein the location includes specific coordinates and a geographic region;
configure one or more sub-applications of an application for the first user based on the social graph and the location of the first user; and
update the one or more sub-applications in response to activities of the first user, wherein the first user is a vehicle itself.

14. The non-transitory computer storage medium of claim 13, further storing computer-executable instructions that, when executed, cause the computer system to generate a recommendation of a list of candidate participants for the first user, wherein the list of candidate participants includes users within a threshold of the location of the first user.

15. The non-transitory computer storage medium of claim 13, wherein the one or more sub-applications include a game server, a local feed, and a maps application.

16. The non-transitory computer storage medium of claim 15, wherein the game server comprises one or more games accessible by the first user, the game server further including a list of users with whom the first user may play the one or more games, wherein users of the list of users are within a threshold geographic distance from the first user.

17. A non-transitory computer storage medium storing computer-executable instructions that, when executed, cause a computer system to perform a computer-implemented method comprising:
determining locations of one or more users of an application of a social networking system;
displaying, via respective display screens of user devices, a local feed to the one or more users based on respective determined locations and respective existing friendships;
displaying, via the respective display screens of the user devices an interactive map to the one or more users based on the respective determined locations and the respective existing friendships;
displaying, via the respective display screens of the user devices, a gaming tab to the one or more users based on the respective determined locations and the respective existing friendships; and
performing activities within the application based on user interactions; wherein the one or more users comprise vehicle users and person users.

18. The non-transitory computer storage medium of claim 17, wherein:
the local feed of a user comprises stories, posted images, posted videos, and posted comments from users within a geographic region of the user and from users connected to the user via friendships;
the interactive map comprises one or more selectable elements including avatars of users within the geographic region, previews of images of places of interest (POI) within the geographic region; and a representation of the geographic region, wherein interactive map is adjustable to show additional geographic regions; and
the gaming tab comprises a list of a plurality of games and a list of available users, wherein the available users are users within the geographic region and users connected to the user via friendships.

19. The non-transitory computer storage medium of claim 18, wherein the user is a vehicle user and a corresponding user device is an infotainment system of a corresponding vehicle.

20. The non-transitory computer storage medium of claim 18, wherein the user is a person user and a corresponding user device is a mobile device.
